(19) United States
(12) Patent Application Publication
(10) Pub. No.: US 2004/0073717 A1
(43) Pub. Date: Apr. 15, 2004

(54) System method and device for dynamic mapping of sonet paths

(76) Inventors: Linda Cline, Forest Grove, OR (US); Christian Maciocco, Tigard, OR (US); Srihari Makineni, Portland, OR (US); Manav Mishra, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/270,709

(22) Filed: Oct. 14, 2002

(51) Int. Cl. G06F 15/16

(52) U.S. Cl. 709/250

(57) ABSTRACT

Disclosed are a system, method and device for selecting a mapping for a data path coupling path terminating equipment (PTE) at a first node to PTE at a second node. The first node may transmit a mapping request message to the second node specifying one or more candidate mappings. The second node may then reply with a selection of one of the candidate mappings or one or more alternative mappings.

### BACKGROUND

1. Field

The subject matter disclosed herein relates to communication systems. In particular, the subject matter disclosed herein relates to communication between nodes in a communication system.

2. Information

Telecommunication data networks typically include a network backbone comprising fiber optic communication links coupling geographically dispersed nodes. Data is typically transmitted across such a network backbone according to the “Synchronous Optical NETwork” (SONET) protocol as indicated in a set of standards provided by the American National Standards Institute (ANSI T1.105.xx) or “Synchronous Digital Hierarchy” (SDH) protocol as indicated in a set of recommendations provided by the International Telecommunications Union (e.g., ITU-T G.707, G. 708, G.709, G.783 and G.784). Under the SONET/SDH protocol, a transmitting node may transmit data frames referred to as “SONET frames” to a destination node.

Equipment at nodes in a SONET/SDH network typically define one or more “SONET Paths” as a logical connection between path-terminating equipment (PTE) at each of the nodes to transmit data frames at a given frame rate. Additionally, PTE at each node of a SONET path may be configured to “map” the SONET path to any one of several SONET path mappings to encapsulate messages which are formatted according to a different communication protocol. Such mapping may be characterized, at least in part, by a mapping type such as packet over SONET (POS), Asynchronous Transfer Mode (ATM), Ethernet over SONET (EOS) and Generic Framing Procedure (GFP).

### BRIEF DESCRIPTION OF THE FIGURES.

Non-limiting and non-exhaustive embodiments of the present invention will be described with reference to the following figures, wherein like reference numerals refer to like parts throughout the various figures unless otherwise specified.

FIG. 1 shows a system comprising nodes to transmit data according to a Synchronous Optical Network/Synchronous Digital Hierarchy (SONET/SDH) protocol according to an embodiment of the present invention.

FIG. 2 shows schematic diagram of path terminating equipment (PTE) at a node according to the system shown in FIG. 1.

FIG. 3 shows a flow diagram illustrating process to request mapping of a SONET/SDH path executed at a transmitting node according to an embodiment of the system shown in FIG. 1.

FIG. 4 shows a flow diagram illustrating process to respond to a request for a mapping of a SONET/SDH path executed at a receiving node according to an embodiment of the process shown in FIG. 3.

FIG. 5 shows a format for a packetized mapping request message according to an embodiment of the process shown in FIG. 3.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Machine-readable” instructions as referred to herein relate to expressions which may be understood by one or more machines for performing one or more logical operations. For example, machine-readable instructions may comprise instructions which are interpretable by a processor compiler for executing one or more operations on one or more data objects. However, this is merely an example of machine-readable instructions and embodiments of the present invention are not limited in this respect.

“Storage medium” as referred to herein relates to media capable of maintaining expressions which are perceivable by one or more machines. For example, a storage medium may comprise one or more storage devices for storing machine-readable instructions or data. Such storage devices may comprise storage media such as, for example, optical, magnetic or semiconductor storage media. However, this is merely an example of a machine-readable medium and embodiments of the present invention are not limited in this respect.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments of the present invention are not limited in this respect.

A “processing system” as discussed herein relates to a combination of hardware and software resources for accomplishing computational tasks. For example, a processing system may comprise a storage medium having machine-readable instructions stored thereon and a processor to execute such machine-readable instructions to accomplish computational tasks. However, this is merely an example of a processing system and embodiments of the present invention are not limited in this respect.

“Synchronous Optical Network” (SONET) as referred to herein relates to a data transmission protocol according to a set of standards provided by the American National Standards Institute (ANSI T1.105.xx). “Synchronous Digital Hierarchy” (SDH) as referred to herein relates to a data transmission protocol according to a set of recommendations provided by the International Telecommunications Union (e.g., ITU-T G.707, G. 708, G.709, G.783 and G.784). “SONET/SDH” as referred to herein relates to aspects of either a SONET or SDH protocol, or both. Hereinafter, “SONET” and “SONET/SDH” may be applied interchangeably.

“Data frames” or “frames” as referred to herein relates to a segment of data which is formatted for transmission from a source to a destination. A data frame may comprise a header portion and a payload portion. A data frame may be formatted for transmission according to a data transmission protocol such as SONET/SDH. However, these are merely examples of a data frame and embodiments of the present invention are not limited in these respects.

A “node” as referred to herein relates to a physical location in a communication network. A node may be coupled to one or more data links. A node may be associated with source or destination for data frames. However, these are merely examples of a node and embodiments of the present invention are not limited in these respects.

A “data path” as referred to herein relates to a logical communication conduit between nodes through which data frames may be transmitted at a given data rate. A physical data link between nodes in a network may provide a plurality of data paths between the nodes. For example, a physical data link may provide a plurality of data paths by interleaving data frames of respective data paths. However, these are merely examples of a data path and embodiments of the present invention are not limited in these respects.

A data path may be associated with a “mapping” of a service to a format of data frames transmitted in a physical data link. For example, a mapping may be associated with a particular mapping type or service type, data rate or transmission granularity. However, these are merely examples of attributes that may be associated with a mapping and embodiments of the present invention are not limited in these respects.

“Path terminating Equipment” (PTE) as referred to herein relates to equipment associated with a node for transmitting or receiving data in a data path. PTE may enable a mapping of a service to one or more data paths terminating at the PTE. However, this is merely an example of a PTE and embodiments of the present invention are not limited in this respect.

A “mapping request message” as referred to herein relates to a message to request a mapping of a service to a data path. For example, a mapping request message may identify one or more “candidate mappings” requested for an associated data path. However, this is merely an example of a mapping request message and embodiments of the present invention are not limited in these respects.

“SONET path overhead” as referred to herein relates to a portion of a SONET frame which is associated with a data path. A SONET path overhead may be provided in a field of a SONET frame that is distinct from a payload portion of the SONET frame. However, this is merely an example of a SONET path overhead and embodiments of the present invention are not limited in these respects.

Briefly, an embodiment of the present invention relates to a system and method of selecting a mapping for a data path coupling a PTE at a first node to PTE at a second node. The first node may transmit a mapping request message to the second node specifying one or more candidate mappings. The second node may then reply with a selection of one of the candidate mappings or one or more alternative candidate mappings. However, this is merely an example embodiment and other embodiments of the present invention are not limited in these respects.

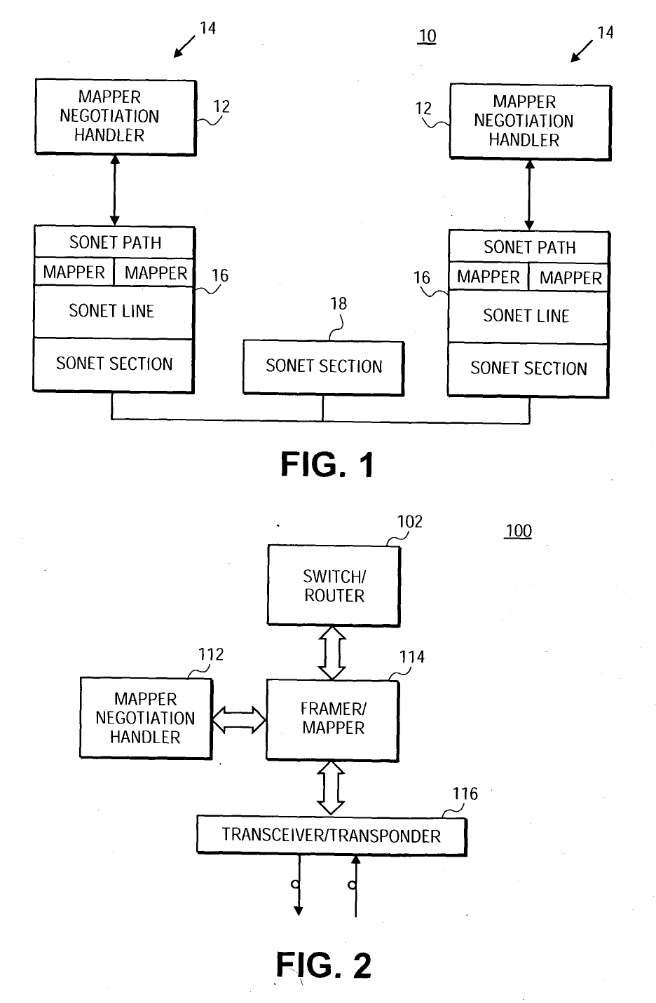

FIG. 1 shows a system 10 comprising nodes 14 to transmit data according to a SONET/SDH protocol according to an embodiment of the present invention. Each node 14 comprises PTE 16 coupled by one or more SONET lines. The SONET lines may be coupled by one or more SONET sections 18. Accordingly, each PTE 16 may comprise the capability to transmit or receive data frames over SONET/SDH line and SONET/SDH section protocols.

The PTEs 16 may provide one or more SONET paths between the nodes 14 which are capable of transmitting SONET/SDH data frames where each SONET path may be associated with a data rate. SONET data frames transmitted in a SONET path may be “mapped” to encapsulate messages for a service according to any one of several communication protocols such as, for example, packet over SONET (POS), Asynchronous Transfer Mode (ATM), Ethernet over SONET (EOS) and Generic Framing Procedure (GFP). However, these are merely examples of types of mappings that may be applied in encapsulating messages in a SONET path and embodiments of the present invention are not limited in these respects.

According to an embodiment, each node 14 may comprise a mapper negotiation handler 12 to selectively change a mapping for a SONET path provided by an associated PTE 16. For example, a first mapper negotiation handler 12 associated with a transmitting PTE 16 of a SONET path may transmit a mapping request message to a second mapper negotiation handler 12 associated with a receiving PTE 16 of the SONET path. The mapping request message may identify one or more candidate mappings for the SONET path. In response to the mapping request message, the second mapper negotiation handler 12 may transmit a reply message to the first mapper negotiation handler 12 to acknowledge receipt of the mapping request message and/or select one of the candidate mappings in the mapping request message. Instead of selecting one of the candidate mappings in the mapping request message, the reply message may identify one or more alternative candidate mappings. However, this is merely an example of how a mapping for a SONET path may be selected and embodiments of the present invention are not limited in these respects.

FIG. 2 shows schematic diagram of path terminating equipment (PTE) 100 at a node according to the system shown in FIG. 1. A framer/mapper 114 may comprise a SONET framer to receive and transmit SONET frames and a mapper to map services to data paths in the SONET frames. The framer/mapper 114 may be coupled to a transceiver/transponder 116 to transmit or receive data in an optical transmission medium. The framer/mapper 114 may provide one or more SONET paths to transmit data to or receive data from a switch/router 102 over a standard data interconnection such as versions of a System Packet Interface (e.g., SPI-4, SPI-4 phase II or SPI 5) or UTOPIA bus, or a proprietary data interconnection. A mapper negotiation handler 112 may comprise logic to select or control a mapping for one or more SONET paths defined in the framer/mapper 114.

The mapper negotiation handler 112 may comprise logic to transmit messages to or receive messages from a mapper negotiation handler associated with another PTE (not shown) to select a mapping for one or more SONET paths between the PTEs.

Logic in the mapper negotiation handler 112 may comprise a processor to execute machine-readable instructions stored in a memory. Alternatively, logic in the mapper negotiation handler may comprise an ASIC or FPGA. In one embodiment, messages may be transmitted between the mapper negotiation handlers of respective PTEs in an in-band message in SONET frames. Alternatively, such messages between the mapper negotiation handlers may be transmitted in an out of band medium such as an Ethernet data link. However, these are merely examples of how negotiation handlers at different PTEs may communicate to select a mapping for a SONET path between the PTEs and embodiments of the present invention are not limited in these respects.

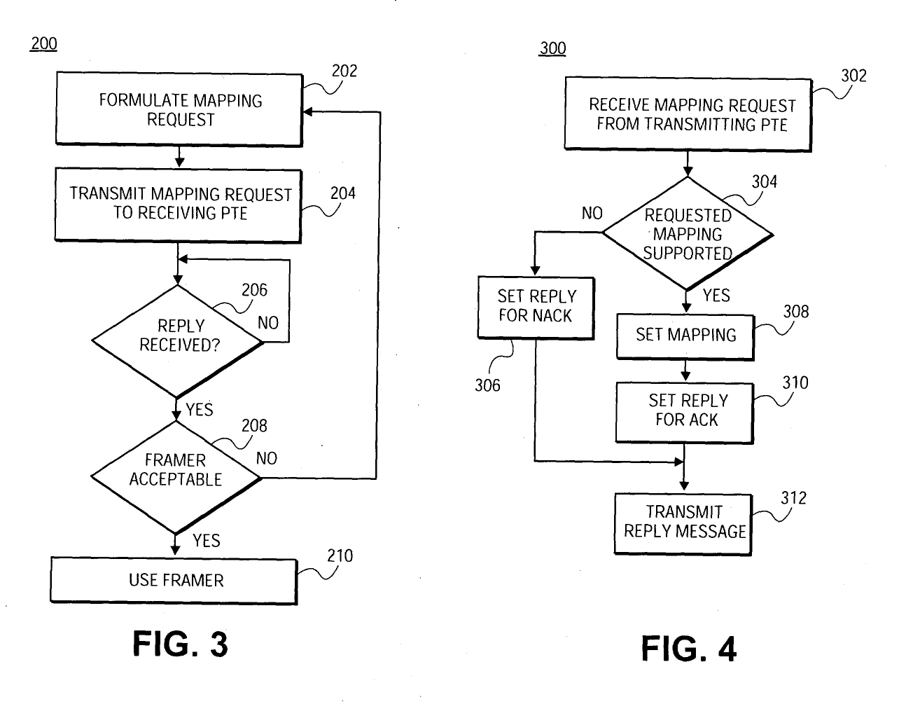

FIG. 3 shows a flow diagram illustrating process 200 executed by a mapper negotiation handler at a transmitting node to request configuration of a SONET/SDH path according to an embodiment of the system shown in FIG. 1. FIG. 4 shows a flow diagram illustrating process 300 executed by a mapper negotiation handler at a receiving node to respond to a request for configuration of a SONET/SDH path according to an embodiment of the process shown in FIG. 3. At block 202, the transmitting node may formulate a mapping request message to identify one or more candidate mappings for the SONET/SDH path. For each candidate mapping, the mapping request message may specify one or more of a candidate mapping type (e.g., POS, ATM, EOS and GFP), a maximum data rate that the transmitting PTE may support at for the candidate mapping type (e.g., OC-3, OC-12, OC-48, OC-192 or OC-768) and a granularity for virtual concatenation that can be supported by the transmitting PTE for the candidate mapping type. However, this merely an example of how a mapping request message may specify one or more candidate mappings and embodiments of the present invention are not limited in these respects.

At block 204, the transmitting PTE may transmit the formulated mapping request message to a mapper negotiation handler of a receiving PTE. As discussed below, the formulated mapping request message may be transmitted using any one of several in-band or out of band messaging techniques. The mapper negotiation handler may then wait for a reply message from the mapper negotiation handler of the receiving PTE at diamond 206. According to an embodiment, a mapping request message transmitted at block 204 may include an identifier or tag uniquely associated with the SONET path to be established. The identifier or tag may then be provided in a received reply message to enable associating the reply message with the corresponding mapping request message at the transmitting node.

Upon receipt of a mapping request message at block 302, the mapper negotiation handler of the receiving PTE may determine whether the receiving PTE is capable of supporting any of the candidate mappings in the mapping request message at diamond 304. If the receiving PTE can support any of the candidate mappings in the received mapping request message, block 308 may configure a framer/mapper (e.g., framer/mapper 114) of the receiving PTE to map the associated SONET path according to a candidate mapping. If the receiving PTE is capable of supporting more than one candidate mapping, the mapper negotiation handler may select the candidate mapping to configure the framer/mapper from among the more than one candidate mappings according to a priority scheme. Upon configuring the framer/mapper at block 308, the mapper negotiation handler may formulate a reply message indicating the selected mapping, and transmit the reply message to the mapper negation handler of the transmitting PTE at block 312.

If the receiving PTE is not capable of supporting any of the candidate mappings provided in the mapping request message received at block 302, the mapper negation handler of the receiving PTE may formulate a reply at block 306 indicating that the receiving PTE cannot support any of the candidate mappings. Alternatively, the reply message may also identify alternative candidate mappings that the receiving PTE is capable of supporting. The formatted reply message may then be transmitted back to the transmitting PTE at block 312.

Upon receiving a reply message from the transmitting PTE at diamond 208, the mapper negotiation handler at the receiving PTE may determine whether a mapping provided in the reply message is acceptable. For example, such a mapping identified in a reply message may be acceptable if the reply message indicates a selection of one of the candidate mappings in the mapping request message transmitted at block 204. Also, a mapping identified in a reply message may be acceptable by listing one or more alternative candidate mappings that are acceptable to the transmitting PTE. If such an alternative candidate mapping identified in the reply message is acceptable, the mapper negotiation handler of the transmitting PTE may configure the framer/mapper (e.g., framer/mapper 114) to commence mapping the SONET path according to the selected mapping. The transmitting PTE may then transmit an acknowledgement message to the mapping negotiation handler of the receiving PTE indicating a selection of a mapping from among alternative candidate mappings in the reply message. If the mapping identified in the reply message is not acceptable, the mapper negotiation handler at the transmitting PTE may commence formulating a new mapping request message at block 202 to specify additional candidate mappings for the SONET path.

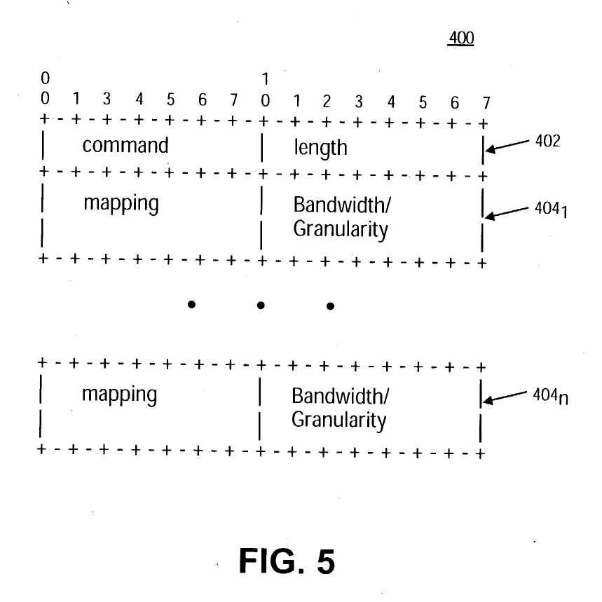

FIG. 5 shows a format for a packetized mapping message 400 according to an embodiment. The mapping message 400 may be used to transmit a mapping request message listing one or more candidate mappings (e.g., at block 204) or transmit a reply to a mapping request message listing one or more alternative candidate mappings (e.g.; at block 312). The mapping message 400 comprises two or more two byte fields. A field 402 comprises a first byte specifying a command such as a mapping request or a mapping request acknowledgement (e.g., in a reply message from a receiving node). Field 402 may also provide a request identifier (e.g., to enable diamond 206 to associate received replies with requests). The second byte of field 402 may provide a length value indicating a count of the number of candidate mappings in the mapping message as provided in subsequent fields 404₁ through 404ₙ.

The mapping message 400 may list each candidate mapping in a two byte field 404. According to an embodiment, the mapping message 400 may list the fields 404 in a prioritized rank order by, for example, indicating a most preferred candidate mapping in the first field (i.e., field 404₁) and indicating a least preferred candidate mapping in the last field (i.e., field 404ₙ). However, this is merely an example of how a mapping message may indicate preferences among multiple candidate mappings and embodiments of the present invention are not limited in this respect.

Each field 404 may associate with a candidate mapping 1) a candidate mapping type in a first byte, and 2) a data rate and granularity in a second byte. The first byte may identify any one of several mapping types such as, for example, POS, ATM, EOS and GFP. However, these are merely examples of mapping types and embodiments of the present invention are not limited in these respects. The second byte may identify a maximum data rate (e.g., in a first four bits of the second byte) and a granularity (e.g., in a second four bits of the second byte).

The maximum data rate may indicate the maximum data rate that the PTE at the node transmitting the mapping message may support at the candidate mapping. Such a maximum data rate may be specified as, for example, OC-3, OC-12, OC-48, OC-192 or OC-768. However, these are merely examples of how a maximum data rate may be specified for a candidate mapping and embodiments of the present invention are not limited in these respects.

The granularity may indicate a granularity at which virtual concatenation can be supported (e.g., the smallest quantity of contiguous data for an STS synchronous payload envelope) by the PTE at the transmitting node may support at the candidate mapping. Such a granularity may be specified as, for example, VT-1.5, VT-2, VT-3, VT-6, STS-1 or STS-3c for SONET networks, or VC-2, VC-3, VC-4, VC-11 or VC-12 for SDH networks. However, these are merely examples of granularities that may be specified for a candidate mapping and embodiments of the present invention are not limited in these respects.

The mapping message 400 may be transmitted (e.g., as a mapping request message from a transmitting PTE at block 204 or as a reply message from a receiving PTE at block 312) using any one of several in-band or out-of-band messaging techniques. In one in-band messaging technique, for example, the mapping message 400 may be encapsulated in a portion of a SONET Path Overhead (such as the “Z3” byte location) associated with the SONET path. In this approach, the mapping message 400 may be transmitted to the receiving node in a series of SONET frames, one byte in each SONET frame. The mapping message 400 may also be encapsulated in a data link frame according to a link-level protocol such as the High-level Data Link Control (HDLC) protocol.

Upon receipt of the data link frame as series of bytes transmitted in a series of in the SONET Path Overhead of a series of data frames, the data link frame may be processed for message detection and verification to receive the mapping message 400. Since the SONET Path Overhead is uniquely associated with the SONET Path, a framer/mapper may forward the received mapping message to a mapper negotiation handler for further processing.

In an alternative to encapsulating the mapping message in a SONET Path Overhead, the mapping message 400 may be encapsulated in a Data Communication Channel (DCC) of a SONET Section or Line Overhead of a SONET frame or in an out of band message. The mapping message 400 may also be encapsulated in a data frame according to a data link protocol such as HDLC. Since neither of these encapsulations of a mapping request are associated with the SONET path, these encapsulations may also include a SONET path identifier (e.g., as an additional field in the mapping message 400 following field 402). However, this is merely an example of how a mapping message may be associated with a particular SONET path coupled between PTEs and embodiments of the present invention are not limited in these respects.

According to an embodiment, a mapping message may be transmitted between PTEs in an out-of-band message according to a Link Management Protocol or RSVP-TE protocol. For example, a mapper negotiation handler may be coupled to an Ethernet connection to receive the mapping request message encapsulated in a Link Management Protocol message or RSVP-TE message. However, this is merely an example of how a mapping request message may be transmitted between PTEs in an out-of-band message and embodiments of the present invention are not limited in these respects.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A method comprising:
transmitting a mapping request message from first path terminating equipment (PTE) at a first node to second PTE at a second node, the mapping request message identifying one or more candidate mappings of a service in a data path between the first and second PTE; and
receiving a reply message from the second PTE identifying one of a selected one of the candidate mappings and one or more alternative candidate mappings.

2. The method of claim 1, the method further comprising transmitting the mapping request message in one or more SONET frames.

3. The method of claim 2, wherein the method further comprises encapsulating the mapping request message in an HDLC message.

4. The method of claim 2, the method further comprising transmitting the mapping request message in a SONET path overhead portion of the one or more SONET frames.

5. The method of claim 2, the method further comprising transmitting the mapping request message in a data communication channel of one of a section overhead portion and a line overhead portion of the one or more SONET frames.

6. The method of claim 5, wherein the mapping request message further comprises channel identification information associated with the data path between the first and second PTE.

7. The method of claim 1, wherein the data path between the first and second PTE is transmitted in a SONET line transmission and method further comprises transmitting the mapping request message in an out of band message independently of the SONET line transmission.

8. The method of claim 7, the method further comprising transmitting the mapping request message according to one of a link management protocol and an RSVP-TE protocol.

9. The method of claim 1, wherein the one or more requested mappings comprise at least one mapping type selected from POS, GFP, ATM and EOS mapping types.

10. A mapper negotiation handler comprising:
logic to initiate transmission of a mapping request message to PTE at a node, the mapping request message identifying one or more candidate mappings of a service in a data path associated with the PTE; and
logic to receive a reply message from the PTE identifying one of a selected one of the requested mappings and one or more alternative candidate mappings.

11. The mapper negotiation handler of claim 10, the mapper negotiation handler further comprising logic to initiate transmission of the mapping request message in one or more SONET frames.

12. The mapper negotiation handler of claim 11, the mapper negotiation handler further comprising logic to encapsulate the mapping request message in an HDLC message.

13. The mapper negotiation handler of claim 11, the mapper negotiation handler further comprising logic to initiate transmission of the mapping request message in a SONET path overhead portion of the one or more SONET frames.

14. The mapper negotiation handler of claim 11, the mapper negotiation handler further comprising logic to initiate transmission of the mapping request message in a data communication channel of one of a section overhead portion and a line overhead portion of the one or more SONET frames.

15. The mapper negotiation handler of claim 14, wherein the mapping request message further comprises channel identification information associated with the data path.

16. The mapper negotiation handler of claim 10, wherein the data path is transmitted in a SONET line transmission, and wherein the mapper negotiation handler further comprises logic to initiate transmission of the mapping request message in an out of band message independently of the SONET line transmission.

17. The mapper negotiation handler of claim 16, the mapper negotiation handler further comprising logic to initiate transmission of the mapping request message according to one of a link management protocol and an RSVP-TE protocol.

18. The mapper negotiation handler method of claim 10, wherein the one or more candidate mappings comprise at least one mapping type selected from POS, GFP, ATM and EOS mapping types.

19. A system comprising:
a framer to transmit or receive sequential SONET frames;
a mapper to map one or more data paths in at least a portion the SONET frames;
one of a switch and a router to receive data from or transmit data in at least one of the data paths; and
a mapper negotiation handler comprising:
logic to initiate transmission of a mapping request message to PTE at a node, the mapping request message identifying one or more candidate mappings of a service in a data path associated with the PTE;
logic to receive a reply message from the PTE identifying one of 1) a selected one of the candidate mappings and 2) one or more alternative candidate mappings; and
logic to configure the mapper to map a service in a data path in response to the reply message.

20. An article comprising:
a storage medium comprising machine-readable instructions stored thereon to:
initiate transmission of a mapping request message to PTE at a node, the mapping request message identifying one or more candidate mappings of a service in a data path associated with the PTE; and
receive a reply message from the PTE identifying one of a selected one of the candidate mappings and one or more alternative candidate mappings.

21. The article of claim 20, wherein the storage medium further comprises machine-readable instructions stored thereon to initiate transmission of the mapping request message in one or more SONET frames.

22. The article of claim 21, wherein the storage medium further comprises machine-readable instructions stored thereon to encapsulate the mapping request message in an HDLC message.

23. The article of claim 21, wherein the storage medium further comprises machine-readable instructions stored thereon to initiate transmission of the mapping request message in a SONET path overhead portion of the one or more SONET frames.

24. The article of claim 21, wherein the storage medium further comprises machine-readable instructions stored thereon to initiate transmission of the mapping request message in a data communication channel of one of a section overhead portion and a line overhead portion of the one or more SONET frames.

25. The article of claim 24, wherein the mapping request message further comprises channel identification information associated with the data path.

26. The article of claim 20, wherein the data path is transmitted in a SONET line transmission, and wherein the storage medium further comprises machine-readable instructions stored thereon to initiate transmission of the mapping request message in an out of band message independently of the SONET line transmission.

27. The article of claim 26, wherein the storage medium further comprises machine-readable instructions stored thereon to initiate transmission of the mapping request message according to one of a link management protocol and an RSVP-TE protocol.

28. The article of claim 20, wherein the one or more candidate mappings comprise at least one mapping type selected from POS, GFP, ATM and EOS mapping types.
